(19) United States
(12) Patent Application Publication
(10) Pub. No.: US 2025/0356766 A1
(43) Pub. Date: Nov. 20, 2025

(54) HUMAN-MACHINE INTERFACE FOR ANTI-INCURSION SYSTEMS AND METHODS

(71) Applicants: Airbus (S.A.S.), Blagnac Cedex (FR); Airbus Operations (S.A.S.), Toulouse (FR)

(72) Inventors: Benjamin MAZOIN, Toulouse (FR); Laura FERSING, Toulouse (FR); Pierre BIZET, Blagnac (FR); Jonathan RIGAUD, Blagnac (FR)

(21) Appl. No.: 19/211,860

(22) Filed: May 19, 2025

Related U.S. Application Data
(60) Provisional application No. 63/649,676, filed on May 20, 2024.

(51) Int. Cl. G08G 5/80; G08G 5/21; G08G 5/23; G08G 5/265; G08G 5/51

(52) U.S. Cl. CPC G08G 5/80; G08G 5/21; G08G 5/23; G08G 5/265; G08G 5/51

(57) ABSTRACT

Systems and methods for managing an anti-incursion function of an aircraft taxiing within an airport environment can be implemented by a monitoring equipment embedded in the aircraft. A human-machine interface of the monitoring equipment can be configured to display a guidance tile that presents context-dependent information as the aircraft taxies within the airport environment. In this way, the pilot of the aircraft can be first warned to ensure that the incursion-risk area (such as a runway) is cleared before operating the aircraft to enter into the incursion-risk area, and if the pilot fails to timely make steps to confirm clearance of the incursion-risk area, then the monitoring equipment can trigger automatic braking so as to stop the aircraft, thus preventing the aircraft from unsafely entering the incursion-risk area.

### CROSS-REFERENCE TO RELATED APPLICATION

This application is a non-provisional application and claims priority to U.S. patent application Ser. No. 63/649,676, filed May 20, 2024, the entire disclosure of which is incorporated by reference herein.

### TECHNICAL FIELD

The subject matter disclosed herein relates generally to a human-machine interface that is used in the operation of an aircraft. More particularly, the subject matter disclosed herein relates to systems and methods for monitoring and controlling the operation of an aircraft during a taxi phase.

### BACKGROUND

During the taxi phase of aircraft operation, where the aircraft travels on the ground within an airport environment, for example to reach a designated runway from which the aircraft should take off, it is common that the aircraft has to cross an intervening runway. The aircraft will also have to enter into its designated runway to line up before takeoff. In such situations, the pilot of the aircraft must wait for an authorization from an air traffic controller (ATC) of the airport's control tower before entering into or crossing over a runway to avoid risks of collision with another aircraft. More generally, the pilot of the aircraft shall take particular care and responsive actions when entering an incursion-risk area during the taxi phase within the airport environment. Monitoring such situations represents a workload for the pilot.

In some circumstances, it would be desirable to reduce the workload of the pilot. For this reason, it would be desirable for an “anti-incursion” function within the aircraft which is able to respond to such situations by preventing the aircraft from entering the incursion-risk area without ensuring beforehand that the situations have been cleared.

### SUMMARY

In accordance with this disclosure, systems and methods for managing an anti-incursion function of an aircraft taxiing within an airport environment are provided, the method being implemented by a monitoring equipment embedded in the aircraft. In one aspect, a method can include displaying, by a human-machine interface of the monitoring equipment, a guidance tile that presents context-dependent information as the aircraft taxies within the airport environment. When the monitoring equipment detects that the aircraft approaches within a first predetermined threshold of an entry point to an incursion-risk area, the method can include updating, by the human-machine interface, the context-dependent information to include a warning indicator; and waiting, by the monitoring equipment, for a confirmation that the incursion-risk area is cleared. When the monitoring equipment detects that the aircraft approaches within a second predetermined threshold of the entry point to the incursion-risk area prior to receiving the confirmation that the incursion-risk area is cleared, the second predetermined threshold being lower than the first predetermined threshold, the method can include updating, by the human-machine interface, the context-dependent information to include a message indicating automatic braking of the aircraft; and initiating automatic braking function of the aircraft when the aircraft fails to stop at most at the entry point to the incursion-risk area.

In any preceding or subsequent example, the method further includes disengaging the automatic braking function of the aircraft when receiving the confirmation that the incursion-risk area is cleared.

In any preceding or subsequent example, displaying the guidance tile includes displaying one or more of a directional instruction identifying a current step in a turn-by-turn guidance instruction; a waypoint indicator identifying the next waypoint along a guidance path; and a next directional instruction identifying a next step in the turn-by-turn guidance instruction.

In any preceding or subsequent example, the method further includes displaying, by the human-machine interface, an action interface that is selectable by human operation via the human-machine interface to confirm that the incursion-risk area is cleared. In particular, in some examples, the incursion-risk area is an area in which a moving or fixed obstacle is detected ahead of the aircraft, and the method includes dynamically creating one or more entry points at a position within the airport environment at a predetermined distance from the incursion-risk area. Alternatively, in some examples, the incursion-risk area is a runway, and the entry point of the incursion-risk area is a position within the airport environment at a predetermined distance from the runway. Further in this regard, in some examples, the method can include displaying, by the human machine interface, an action interface that is selectable by human operation via the human-machine interface to send a clearance request to air traffic control for obtaining authorization to enter the runway; and receiving from the air traffic control an authorization message in response to the clearance request which confirms that the runway is cleared.

In any preceding or subsequent example, in addition to displaying the warning indicator, the method can include determining a distance between the position of the aircraft and the entry point of the incursion-risk area and displaying, in the context-dependent information of the guidance tile, a gauge that identifies an amount of room available for maneuvering the aircraft before the second predetermined threshold.

In any preceding or subsequent example, the warning indicator is accompanied by an instruction to brake.

In any preceding or subsequent example, the warning indicator is accompanied by a sound indicating proximity to the entry point.

In any preceding or subsequent example, the method further includes displaying a navigation map of at least part of the airport environment which includes representations of runways and taxiways of the airport environment; displaying in real-time a representation of the actual position of the aircraft in the airport environment on the navigation map; displaying a guidance path on the navigation map identifying a path to be followed by the aircraft from the actual position to reach a destination in the airport environment; and displaying one or more markers on the navigation map indicating waypoints along the guidance path, wherein the entry point to the incursion-risk area is represented by one of the one or more markers. In such examples, a stop bar crossing the taxiway at the entry point to the incursion-risk area can be represented on the navigation map in association with the one of the one or more markers representing the entry point. In addition, in some examples, updating the context-dependent information to include a warning indicator can include one or more of changing a color of the one of the one or more marker to one or more predetermined alert color and changing a color of a portion of the guidance path leading to the entry point to the incursion-risk area to the one or more predetermined alert color.

In some embodiments, a non-transitory computer-readable storage medium having executable instructions stored thereon, which when read from the non-transitory computer-readable storage medium and executed by a processing circuit of a computing device causes the computing device to execute the method above, in any one of the preceding examples.

Examples of the present disclosure provide numerous advantages. For example, the pilot of the aircraft can be first warned to ensure that the incursion-risk area (such as a runway) is cleared before operating the aircraft to enter into the incursion-risk area, and if the pilot fails to timely make steps to confirm clearance of the incursion-risk area, then the monitoring equipment can trigger automatic braking so as to stop the aircraft, thus preventing the aircraft from unsafely entering the incursion-risk area.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 schematically represents a top view of an aircraft having a monitoring equipment according to an embodiment of the presently disclosed subject matter.

FIG. 2 schematically represents an example of a hardware system which can be used to implement the monitoring equipment according to an embodiment of the presently disclosed subject matter.

FIGS. 3-9 are representative graphical displays of a human-machine interface that correspond to steps in a method for managing an anti-incursion function of an aircraft within an airport environment according to an embodiment of the presently disclosed subject matter.

FIGS. 10 and 11 are representative graphical displays of a human-machine interface that correspond to steps in a method for managing an anti-incursion function of an aircraft within an airport environment according to a further embodiment of the presently disclosed subject matter.

### DETAILED DESCRIPTION

The present subject matter provides a human-machine interface for managing a monitoring functionality for taxi operations of an aircraft during which the aircraft travels through an airport environment until a destination, such as a designated runway to carry out the take-off or an airport's gate. In particular, the monitoring functionality can be configured to protect the aircraft from an unwanted incursion into an incursion-risk area, more particular to prevent from unsafe entry in a runway or from a collision with a moving or fixed obstacle. This human-machine interface is configured to provide feedback to the pilot/operator regarding such a monitoring functionality, to clearly communicate steps to be taken to protect the aircraft from an unwanted incursion into an incursion-risk area, and to provide an interactive interface with which the pilot can interact to control the operation of the aircraft. In addition, the human-machine interface can enable the pilot to easily obtain authorization from the air traffic control (ATC) of the airport's control tower to enter a runway, which confirms that the runway is cleared, and disarm anti-incursion protection in order to proceed to enter the runway (for example, to cross an intervening runway).

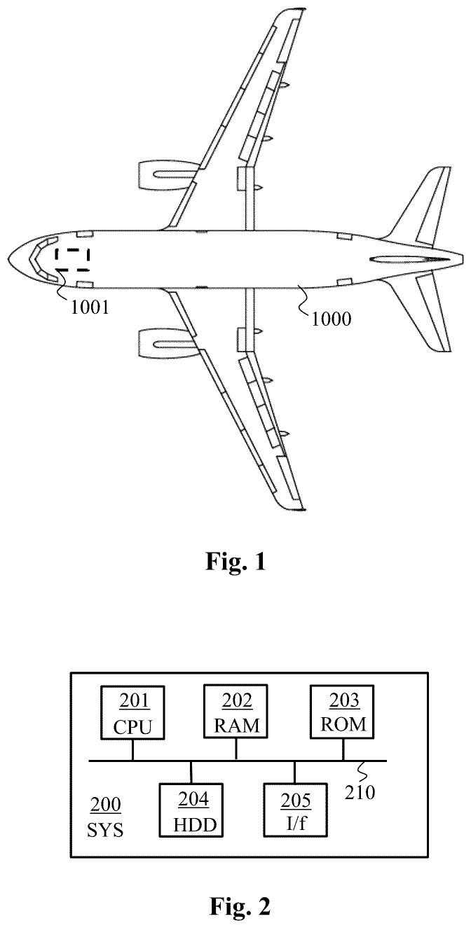

FIG. 1 schematically represents a top view of an aircraft, generally designated 1000. The aircraft 1000 includes avionics equipment, which provides computing ability to the aircraft 1000. The aircraft 1000 further includes human-machine interface enabling devices in the cockpit in conjunction with the avionics equipment, such as displays or touch screens or EFB (Electronic Flight Bag) device, thus enabling interactions with the pilot of the aircraft. In some examples, the aircraft's avionics equipment includes a position-awareness equipment enabling the avionics to know in real-time the geographical position of the aircraft 1000, such as a GPS (Global Positioning System) receiver, a GLONASS (Global Navigation Satellite System) receiver, and/or a Galileo receiver. In some examples, the aircraft's avionics equipment further includes at least one communication interface configured to enable vocal and/or text communications with the airport's control tower. The aircraft 1000 embeds a monitoring equipment 1001, for example as part of the aircraft's avionics equipment, which is configured for implementing an anti-incursion function as disclosed.

FIG. 2 schematically represents an example of a hardware system SYS 200 which can be used to implement the monitoring equipment 1001. The hardware system SYS 200 can be used as well to implement other aircraft's avionics functionalities.

According to the shown example, the hardware system SYS 200 comprises at least the following components interconnected by a communication bus 210: a processor, microprocessor, microcontroller or CPU (Central Processing Unit) 201; a RAM (Random-Access Memory) 202; a ROM (Read-Only Memory) 203 or an EEPROM (Electrically-Erasable Programmable ROM) such as a Flash memory; an HDD (Hard-Disk Drive) 204 or an SD (Secure Digital) card reader, or any other device adapted to read information stored on non-transitory information storage medium; and at least one interface I/f 205 including preferably a communication interface to enable communicating with other equipment of the aircraft 1000 or with the ATC.

The CPU 201 is capable of executing instructions loaded into the RAM 202 from the ROM 203 or from an external memory, such as an SD card. After the hardware system SYS 200 has been powered on, the CPU 201 is capable of reading instructions from the RAM 202 and executing these instructions. The instructions form one or more computer program products that cause the CPU 201 to perform some or all of the actions disclosed herein with respect to the monitoring equipment 1001 or other aircraft's avionics equipment.

The subject matter disclosed herein can be implemented in or with software in combination with hardware and/or firmware. For example, the subject matter described herein can be implemented in software by execution of a set of instructions or program by a processor or processing unit or a programmable computing machine, such as a DSP (Digital Signal Processor). The subject matter disclosed herein can be implemented in hardware form by a machine or a dedicated chip or chipset, such as an FPGA (Field-Programmable Gate Array) or an ASIC (Application-Specific Integrated Circuit). In general, the monitoring equipment 1001 and the aircraft's avionics equipment comprise processing electronics circuitry adapted and configured for implementing the subject matter disclosed herein.

In some examples, the present subject matter can be implemented by at least one avionics computer of the aircraft 1000, in relation with a display in the cockpit. As an alternative, the present subject matter can be implemented on an EFB (Electronic Flight Bag) device, receiving information from the aircraft's avionics equipment.

Some examples of the disclosed system may be implemented, for example, using a storage medium, a computer-readable medium or an article of manufacture which may store an instruction or a set of instructions that, when executed by a machine (e.g., processor, processing circuit, or microcontroller), may cause the machine to perform a method and/or operations in accordance with embodiments of the disclosure. In addition, a server or database server may include machine readable media configured to store machine executable program instructions. Such a machine may include, for example, any suitable processing platform, computing platform, computing device, processing device, computing system, processing system, computer, processor, or the like, and may be implemented using any suitable combination of hardware, software, firmware, or a combination thereof and utilized in systems, subsystems, components, or sub-components thereof. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

In one aspect, the monitoring equipment 1001 is configured to provide a human-machine interface that is configured to monitor the position of the aircraft 1000 within an airport environment and provide one or more alerts and/or cues to the pilot of the aircraft 1000 upon identification of possible incursions into an incursion-risk area during a taxi phase of operation of the aircraft. As detailed hereafter, in some examples, the incursion-risk area comprises a runway. In some other examples, the incursion-risk area comprises a taxiway crossroad.

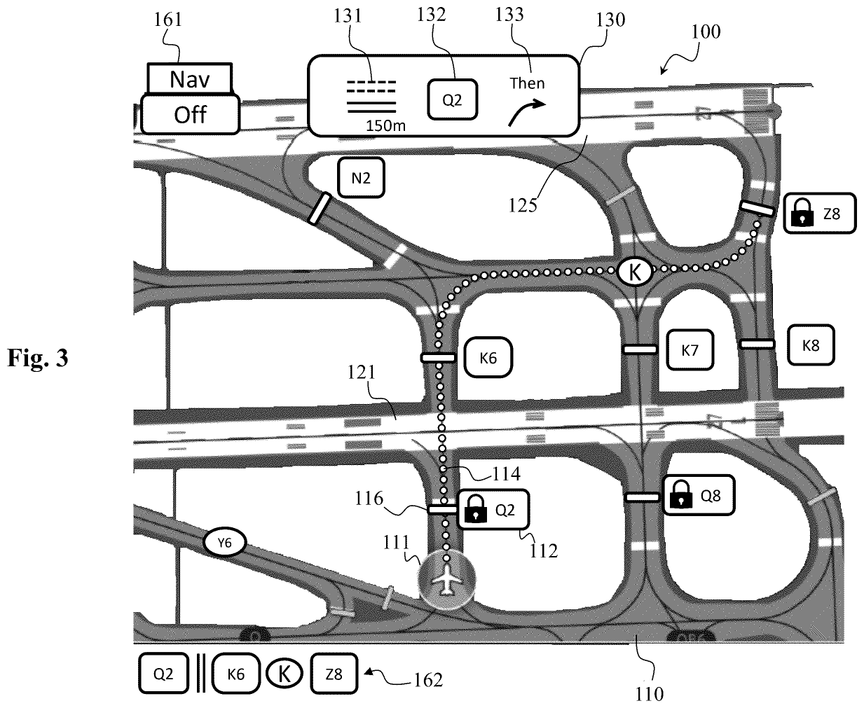

FIGS. 3-11 schematically represent embodiments of a human-machine interface 100, generally designated 100, provided by the monitoring equipment 1001, which present information about the operation of the aircraft 1000 with respect to the airport environment.

In some examples, this information can include a navigation map 110 of at least a portion of the airport environment, a representation 111 of an actual position in real-time of the aircraft 1000 relative to runways and taxiways of the airport environment, one or more marker 112 indicating waypoints along the runways and taxiways, and a guidance path 114 identifying a path (route) to be followed from the actual position of the aircraft 1000 to a designated destination, such as but not limited to a take-off runway 125 or an airport gate.

Referring to FIG. 3, several waypoints are illustratively represented: Q2, Q8, K, K6, K7, K8, N2, Y6 and Z8. The waypoints Q2, K6, K and Z8 are on the guidance path 114 to the designated take-off runway 125. It can be noted that, on the navigation map 110, each entry point to any incursion-risk area corresponding to one runway is represented by a marker identifying one of the waypoints, such as at a position within the airport environment at a predetermined distance from the associated runway.

To do so, in some examples, the monitoring equipment 1001 obtains the guidance path 114 to the destination of the taxi phase of the aircraft 1000 within the airport environment, for example as many conventional navigation system do. The monitoring equipment 1001 then obtains waypoints on the guidance path 114, and among the waypoints, identifies if at least one waypoint corresponds to one entry point of a corresponding incursion-risk area. If so, the monitoring equipment 1001 arms the anti-incursion function for the at least one waypoint identified (i.e., entry point is “locked”).

In situations in which a waypoint is associated with one entry point of an incursion-risk area, the corresponding marker 112 preferably includes a graphical symbol (e.g., a padlock symbol) in addition to a name/identifier of the waypoint that indicates that an incursion-specific action may be necessary once the aircraft arrives at the waypoint (i.e., entry point is “locked”).

In some examples, the monitoring equipment 1001 can anticipate situations in which the aircraft fails to follow the guidance path 114 and may attempt to enter the incursion-risk area by another entry point than initially foreseen. Thus, as shown in FIG. 3, the waypoint Q8 is locked although following the guidance path 114 would lead to attempt entering the intervening runway 121 through the waypoint Q2.

In some examples, the human-machine interface 100 further includes a guidance tile 130 that presents context-dependent information to the pilot as the aircraft proceeds along the guidance path 114, namely as the aircraft 1000 taxies within the airport environment. The contents of the guidance tile 130 is updated in real-time upon changes of the context-dependent information. Referring to FIG. 3, for example, the guidance tile 130 can include a directional instruction 131 identifying a current step in a turn-by-turn guidance instruction (here, the directional instruction 131 indicates to move forward), a waypoint indicator 132 identifying the next waypoint along the guidance path 114 (here, the next waypoint is Q2), and a next directional instruction 133 identifying a next step in the turn-by-turn guidance instruction after the waypoint in question (here, the next directional instruction 133 indicates to turn right). In situations in which the next waypoint is associated with an entry point of an incursion-risk area corresponding to a runway, the waypoint indicator 132 may include a graphical symbol (e.g., a padlock symbol) in addition to a name/identifier of the waypoint which indicates that an incursion-specific action may be necessary once the aircraft arrives at the waypoint (e.g., entry is “locked”).

In some examples, the human-machine interface 100 further includes a banner 162 in which a remaining portion of the guidance path 114 is represented as a list of successive key point indications. As shown in FIG. 3, key points of the remaining portion of the guidance path 114 from the position of the aircraft 1000 include the waypoint Q2, the intervening runway 121, the waypoint K6, the waypoint K, and the waypoint Z8. In some examples, the human-machine interface 100 includes further information items or action buttons 161, such as a button to close the navigation map 110 as shown in FIG. 3.

In the illustrated examples, the waypoint Q2 is an entry point to the intervening runway 121. On the illustrative navigation map 110 in FIG. 3, the marker 112 of the waypoint Q2 is associated with a representation of a bar 116 crossing the taxiway. The bar 116 is at a position at or near an entrance to the intervening runway 121. The bar 116 is a stop bar since the waypoint Q2 is a blocking entry point (e.g., entry is “locked”) to the intervening runway 121, which means that at least one specific action has to be performed before the aircraft 1000 enters the intervening runway 121. Other markers of waypoints on the navigation map 110, including waypoints on the guidance path 114, are associated with a representation of a bar crossing the taxiway. These bars are not stop bars with respect to the guidance path 114, since these waypoints are not entry points of any runway when following the guidance path 114 as shown in FIG. 3, but these waypoints (namely, Q8, K6, K7, K8) may become entry points of a runway (namely, the runway 121) for other guidance paths through the airport.

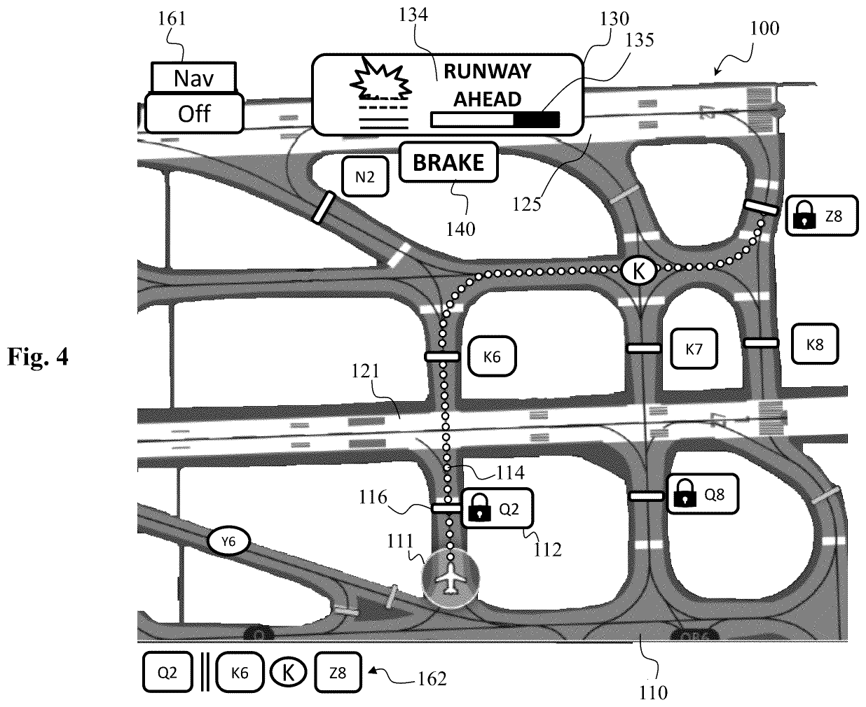

Referring to FIG. 4, the guidance tile 130 can display a warning indicator 134 as the aircraft approaches the entry point of the incursion-risk area in question. In some examples, the guidance tile 130 further displays a distance gauge 135 that displays an amount of room available for maneuvering the aircraft 1000 before an automated response may be triggered (e.g., automatic braking) in view of the remaining distance between the aircraft 1000 and the entry point of the incursion-risk area in question.

In some examples, one or more of the warning indicator 134, the distance gauge 135, the marker 112 identifying the concerned waypoint (here Q2), and/or the representation of the entry point itself (i.e., the bar 116) can be displayed in a color (e.g., amber) that is selected to alert the pilot of an upcoming waypoint. In some examples, the warning indicator 134, the distance gauge 135, the marker identifying the concerned waypoint (here Q2), and/or the representation of the entry point itself (i.e., the bar 116) can be displayed in another color (e.g., red) as the aircraft further nears the waypoint in question. In some examples, the warning indicator 134 and/or the distance gauge 135 and/or the marker identifying the concerned waypoint (here Q2) and/or the representation of the entry point itself (i.e., the bar 116) can turn into the other color a predetermined time (e.g., 2 seconds) before the waypoint in question is estimated to be reached. In some examples, the warning indicator 134, the distance gauge 135, the marker identifying the concerned waypoint (here Q2), and/or the representation of the entry point itself (i.e., the bar 116) can turn into the other color when the aircraft 1000 reaches a position at a predetermined threshold from the waypoint in question (here Q2).

To do so, in some examples, the monitoring equipment 1001 is configured to detect that the position of aircraft 1000, as provided by the position-awareness equipment, is approaching the geographical position of the waypoint in question on the airport's taxiway below a first predetermined threshold TH1, such as a first distance threshold THd1 or a first travel time threshold THt1. The monitoring equipment 1001 can then update the appearance and information of the human-machine interface 100, such as the context-dependent information of the guidance tile 130 to include the warning indicator 134.

In some examples, the human-machine interface 100 further displays an action instruction 140, which accompanies the warning indicator 134, to identify one or more recommended action, such as an instruction to brake (“BRAKE”). In the illustrated example, the warning indicator 134 identifies that the aircraft is approaching an intervening runway 121, the distance gauge 135 identifies the distance to the entry point, and the action instruction 140 prompts the pilot to initiate a braking action. In addition, in some examples, the graphical elements displayed on the human-machine interface 100 can be accompanied by one or more corresponding sounds, such as a recorded or synthesized voice emphasizing the action instruction (e.g., braking instructions) and/or a sound indicating proximity to the waypoint in question.

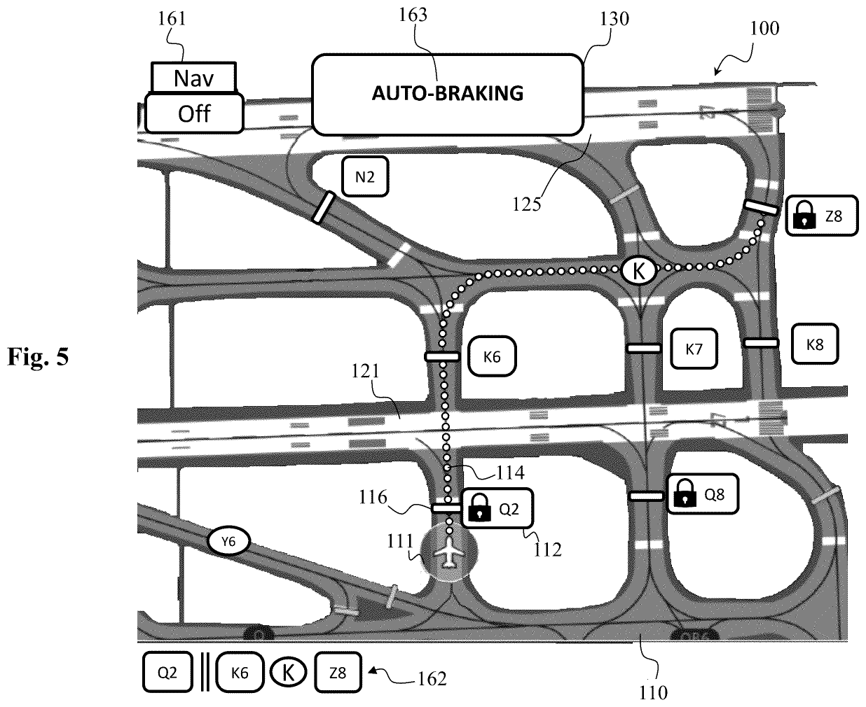

Referring to FIG. 5, in some examples, in the case where the pilot does not take the recommended action (e.g., braking) as the aircraft 1000 approaches waypoint in question (namely the entry point of the intervening runway 121), an automated response (i.e., automatic braking) can be triggered, which can be indicated by the guidance tile 130 by a corresponding indication 163 (e.g., Auto-braking).

To do so, the monitoring equipment 1001 detects that the position of aircraft 1000, as provided by the position-awareness equipment, is approaching the geographical position of the waypoint in question on the airport's taxiway below a second predetermined threshold TH2, such as a second distance threshold THd2 or a second travel time threshold THt2. The second predetermined threshold TH2 is lower than the first predetermined threshold TH1 (e.g., the second distance threshold THd2 is lower than the first distance threshold THd1 and/or the second travel time threshold THt2 is lower than the first travel time threshold THt1). The monitoring equipment 1001 then updates the appearance and information of the human-machine interface 100 consequently. The monitoring equipment 1001 then initiates the automated response (i.e., automatic braking), typically by instructing the aircraft's avionics equipment to trigger the automated response (i.e., automatic braking).

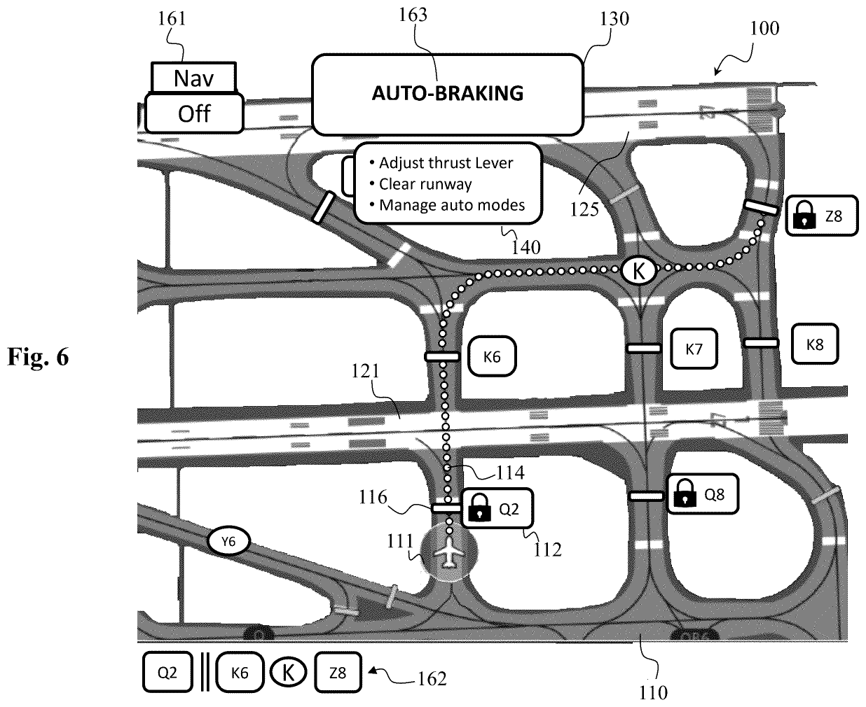

Referring to FIG. 6, in such a situation, the action instruction 140 can display the steps to restart taxiing. For example, the action instruction 140 can display instructions for the pilot to adjust the thrust lever (e.g., Auto or Idle for manual), clear runway, and manage auto modes (e.g., operate the flight control unit to adjust the speed to taxi in “auto” or turn the speed auto button to taxi in “taxi”).

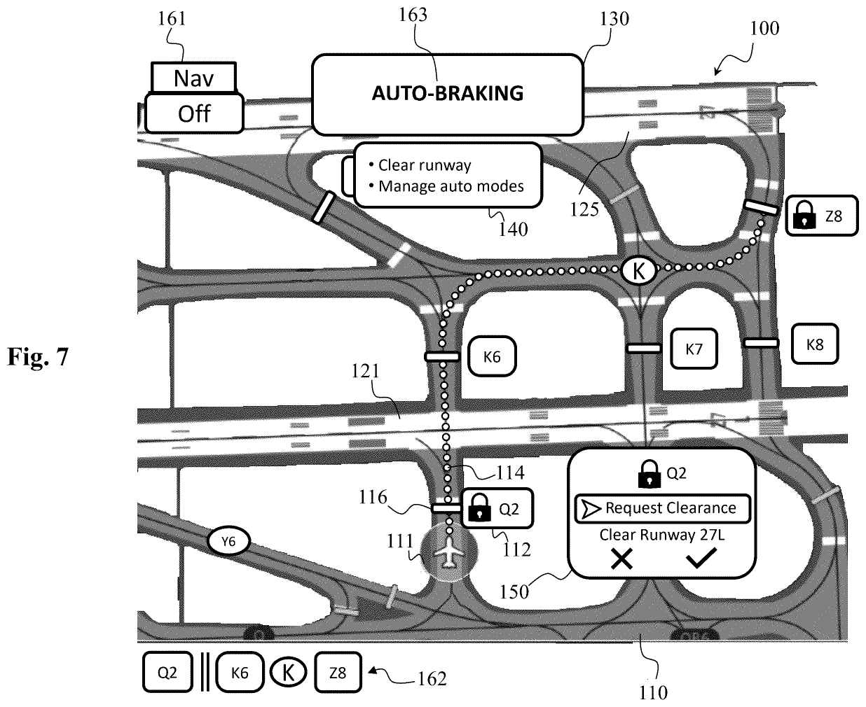

Before automatic braking is triggered and/or after the aircraft has completely stopped, the pilot can request authorization with air traffic control (ATC) to enter the intervening runway 121. This request may be done via the human-machine interface 100. Referring to FIG. 7, the pilot can select the marker 112 corresponding to the approaching waypoint (here Q2), and an action interface 150 can be displayed with which the pilot can interact (the action interface 150 and items thereon are selectable by human operation via the human-machine interface). In the situation illustrated in FIG. 7, the action interface 150 includes a “Request clearance” button that the pilot can select to automatically send a clearance request to the ATC. In a variant, the action interface 150 can include a button for setting up a voice communication with the ATC to enable the pilot to vocally request clearance of the intervening runway 121. It can be noted that the pilot may communicate with the ATC with another piece of equipment, namely without using the human-machine interface. Therefore, in some examples, the action interface 150 can include a button enabling the pilot to confirm that the incursion-risk area is cleared (e.g., authorization obtained from the ATC through another channel).

To do so, the monitoring equipment 1001 instructs the communication interface to send the clearance request (or to open a voice channel). The monitoring equipment 1001 waits for a confirmation that the incursion-risk area is cleared. To do so, the monitoring equipment 1001 waits for a confirmation that an authorization to enter the incursion-risk area (namely, the intervening runway 121) is issued. The confirmation can be an authorization message from the ATC received in response to the clearance request. Alternatively, the confirmation can be made by the pilot via the action interface confirming that the incursion-risk area is cleared (e.g., selecting the tick shown in FIG. 7 on the action interface 150).

In some examples, the monitoring equipment 1001 can be configured to display the action interface 150 on the human-machine interface 100 as soon as the first threshold TH1 is reached by the aircraft 1000.

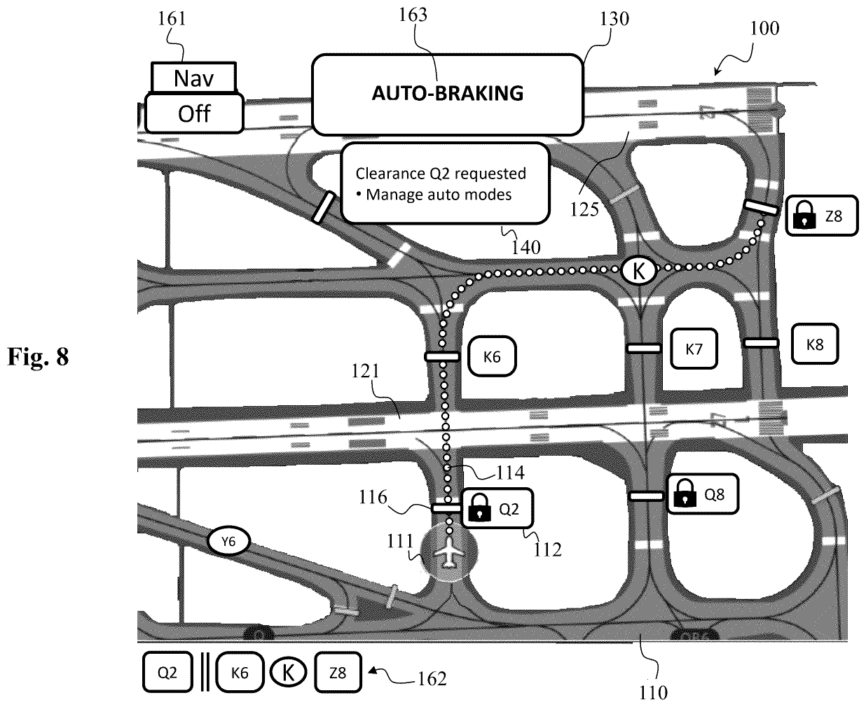

Referring to FIG. 8, the action instruction 140 can be updated to indicate that the request has been sent. If the ATC validates the clearance request, the monitoring equipment 1001 receives an authorization response and the pilot can receive a corresponding notification via the human-machine interface 100 inviting him to proceed with the incursion into the incursion-risk area in question (here the intervening runway 121). In case of vocal communications, the pilot can confirm that the incursion-risk area is cleared, by using a dedicated button of the action interface 150 in the human-machine interface 100 when approval from the ATC has been received.

It is apparent from the foregoing disclosure that the monitoring equipment 1001 initiates the automatic braking function of the aircraft 1000 when the aircraft 1000 fails to stop at most at the entry point to the incursion-risk area prior to receiving the confirmation that the incursion-risk area is cleared. It can be understood that, in this case, when the confirmation of the incursion-risk area is cleared is received, the monitoring equipment 1001 can be configured to disengage the automatic braking function of the aircraft 1000 and thus disarm the anti-incursion function for the incursion-risk area in question.

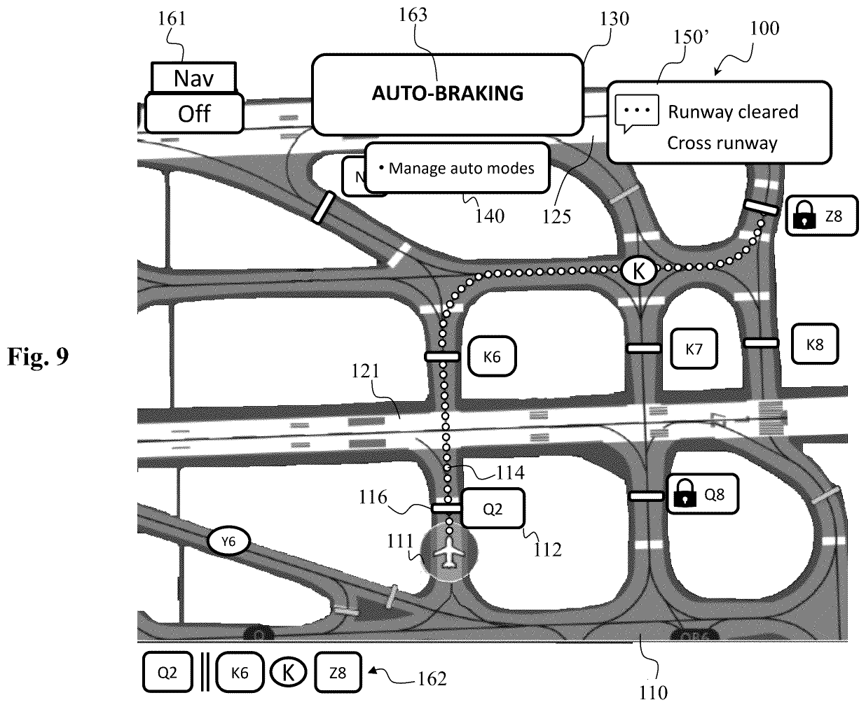

For example, referring to FIG. 9, a new action interface 150′ can be displayed indicating that the intervening runway 121 is cleared. The action instruction 140 can again be updated to identify remaining actions to be taken. For example, in the illustrated embodiment, the action “Manage auto mode” is still visible, and the pilot can choose to remove the Auto Speed mode to continue in manual or to continue in Auto Speed mode.

Moreover, as confirmation that the incursion-risk area is cleared is received, the waypoint Q2 is unlocked (e.g., removal of the padlock symbol in the marker 112 of the waypoint Q2). In some examples, the default color of the marker 112 may also be restored (e.g., turns from red to blue). As soon as the aircraft 1000 enters the intervening runway 121, the guidance tile 130 can be configured to revert to its basic navigation tile configuration, as shown illustratively in FIG. 3, to again provide turn-by-turn guidance to the next waypoint (here K).

In another aspect, if auto-taxi function is activated, the monitoring equipment 1001 can be configured to instruct automatic braking as already mentioned so as to make the aircraft 1000 brake until a complete stop is achieved at most at the entry point of the intervening runway 121 (e.g., where the stop bar 116 is positioned on the navigation map 110).

In such a configuration where auto-taxi function is activated, the human-machine interface 100 does not need to present as many warning indicators as detailed above as the aircraft 1000 approaches the entry point of the intervening runway 121 (e.g., waypoint Q2). There is indeed no need to prompt the pilot to brake, which means that there is no need for the warning indicator 134 and/or the distance gauge 135 on the guidance tile 130, or even no need for displayed color change. Rather, in some examples, the guidance tile 130 can be configured to simply indicate that the aircraft 1000 is approaching the intervening runway 121, and the action instruction 140 can identify that autobraking is applied or is soon to be applied.

In some examples, when auto-taxi function is activated, the guidance path 114 can be configured to have a different appearance compared with its appearance when the auto-taxi function is not activated (different shape and/or different color).

When auto-taxi function is activated, the approach for requesting clearance from ATC via the human-machine interface 100 to enter the intervening runway 121 can be performed as discussed above. In some examples, the new action interface 150′ can include a button that the pilot can select to indicate a desire to continue in auto-taxi mode. Alternatively, the pilot can choose to use the flight control unit to manually control the aircraft operation during taxi.

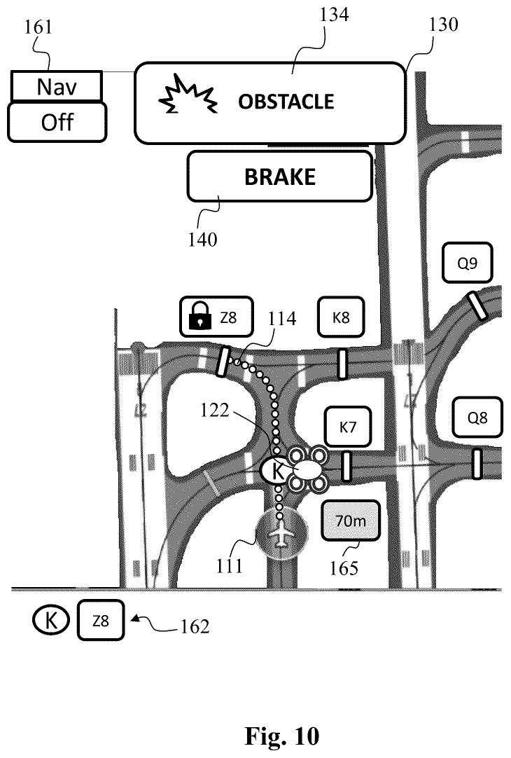

In another aspect, similar protection behavior can be provided in the case of a moving or fixed obstacle on the path ahead of the aircraft 1000. Referring to FIG. 10, a representation 122 of an obstacle on the path ahead of the aircraft 1000, which has been identified by the obstacle detection system, appears on the navigation map 110. An incursion-risk area is automatically created around the obstacle in question. The monitoring equipment 1001 then dynamically creates one or more entry points to the incursion-risk area (at a position at a predetermined distance from the incursion-risk area in question) to arm the anti-incursion function.

The position of the representation 122 of the obstacle in the navigation map 110 is updated in real-time by the human-machine interface 100 according to the position of the obstacle, which may be moving, as detected by the obstacle detection system. The incursion-risk area may thus be moving and consequently the one or more entry points may be dynamically adjusted and even one or more entry points may be added or removed in accordance with the position of the incursion-risk area in question with respect to the path of the aircraft 1000.

The human-machine interface 100 can be configured to update the guidance tile 130 to alert the pilot to the risk of the obstacle and/or to display an action instruction 140 to identify one or more recommended action, such as a message presenting an instruction to brake.

In some examples, the guidance tile 130 can display a warning indicator 134 as the aircraft 1000 approaches an area in which the moving or fixed obstacle is detected to be present. In some examples, the guidance tile 130 further displays the distance gauge 135 that displays the distance before an automated response may be triggered (e.g., automatic braking). The warning indicator 134, the distance gauge 135, and/or the representation 122 of the obstacle can be displayed in a color (e.g., amber) that is selected to alert the pilot of an upcoming obstacle.

To do so, the monitoring equipment 1001 detects that the position of aircraft 1000, as provided by the position-awareness equipment, is approaching the geographical position of the obstacle below the first distance threshold THd1 or below the first travel time threshold THt1. The monitoring equipment 1001 then adapts the appearance and information of the human-machine interface 100 consequently.

The warning indicator 134, the distance gauge 135, and/or the representation 122 of the obstacle can be displayed in another color (e.g., red) as the aircraft 1000 further nears the obstacle in question. In some examples, the warning indicator 134, the distance gauge 135, and/or the representation 122 of the obstacle can turn into the other color a predetermined time (e.g., 2 seconds) before the obstacle is estimated to be reached. In some examples, the warning indicator 134, the distance gauge 135, and/or the representation 122 of the obstacle can turn into the other color when the aircraft 1000 reaches a position at a predetermined threshold distance from the obstacle.

In some examples, the display elements provided by the human-machine interface 100 can be accompanied by a sound composed of a recorded or synthesized voice emphasizing the braking instruction and/or a sound indicating proximity to the obstacle.

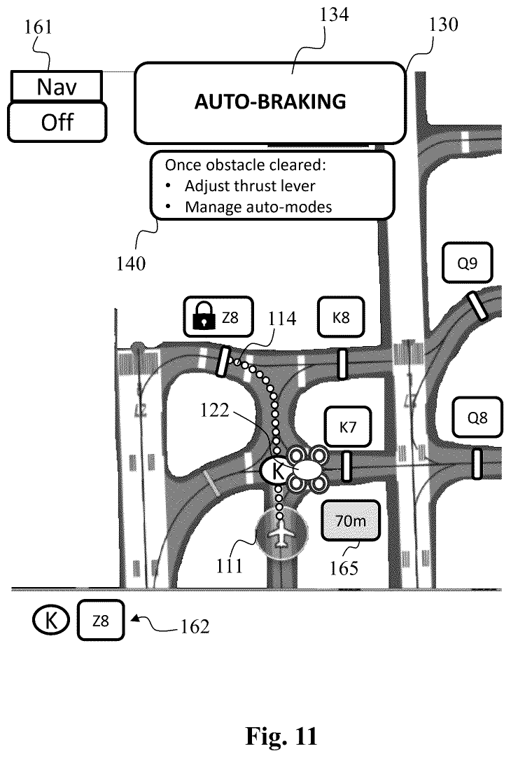

In some examples, referring to FIG. 11, in the case where the pilot does not take the recommended action (e.g., braking) as the aircraft 1000 approaches the obstacle, an automated response (i.e., automatic braking) can be triggered, which can be indicated by the guidance tile 130 by a corresponding indication 163 (e.g., Auto-braking).

To do so, the monitoring equipment 1001 detects that the position of aircraft 1000, as provided by the position-awareness equipment, is approaching the geographical position of the obstacle below the second distance threshold THd2 or below the second travel time threshold THt2. The monitoring equipment 1001 then adapts the appearance and information of the human-machine interface 100 consequently. The monitoring equipment 1001 then instructs the aircraft's avionics equipment to trigger the automated response (i.e., automatic braking).

Additionally, the action instruction 140 can be displayed to indicate steps that can be performed to resume taxiing once the obstacle is cleared. For example, when the aircraft 1000 is stopped, the pilot can disengage the anti-incursion function to further maneuver the aircraft 1000. This can be done using an action interface that is selectable by human operation via the human-machine interface to confirm that the incursion-risk area is cleared (as already explained with respect to the action interface 150). Alternatively, the anti-incursion function can be configured to disengage automatically if the obstacle is detected, by the obstacle detection system, to move out of the path of the aircraft 1000 (i.e., out of the guidance path 114).

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for managing an anti-incursion function of an aircraft taxiing within an airport environment, the method being implemented by monitoring equipment embedded in the aircraft, the method comprising:
displaying, by a human-machine interface of the monitoring equipment, a guidance tile that presents context-dependent information as the aircraft taxies within the airport environment;
wherein, when the monitoring equipment detects that the aircraft approaches within a first predetermined threshold of an entry point to an incursion-risk area, the method comprises:
updating, by the human-machine interface, the context-dependent information to include a warning indicator; and
waiting, by the monitoring equipment, for a confirmation that the incursion-risk area is cleared; and
wherein, when the monitoring equipment detects that the aircraft approaches within a second predetermined threshold of the entry point to the incursion-risk area prior to receiving the confirmation that the incursion-risk area is cleared, the second predetermined threshold being lower than the first predetermined threshold, the method comprises:
updating, by the human-machine interface, the context-dependent information to include a message indicating automatic braking of the aircraft; and
initiating automatic braking function of the aircraft when the aircraft fails to stop at most at the entry point to the incursion-risk area.

2. The method according to claim 1, comprising disengaging the automatic braking function of the aircraft when receiving the confirmation that the incursion-risk area is cleared.

3. The method of claim 1, wherein displaying the guidance tile comprises displaying one or more of:
a directional instruction identifying a current step in a turn-by-turn guidance instruction;
a waypoint indicator identifying a next waypoint along a guidance path; or
a next directional instruction identifying a next step in the turn-by-turn guidance instruction.

4. The method according to claim 1, comprising displaying, by the human-machine interface, an action interface that is selectable by human operation via the human-machine interface to confirm that the incursion-risk area is cleared.

5. The method according to claim 1, wherein the incursion-risk area comprises an area in which a moving or fixed obstacle is detected ahead of the aircraft; and
wherein the method comprises dynamically creating one or more entry points at a position within the airport environment at a predetermined distance from the incursion-risk area.

6. The method according to claim 1, wherein the incursion-risk area comprises a runway; and
wherein the entry point of the incursion-risk area is a position within the airport environment at a predetermined distance from the runway.

7. The method according to claim 6, comprising:
displaying, by the human machine interface, an action interface that is selectable by human operation via the human-machine interface to send a clearance request to air traffic control for obtaining authorization to enter the runway; and
receiving from the air traffic control an authorization message in response to the clearance request which confirms that the runway is cleared.

8. The method according to claim 1, wherein, in addition to displaying the warning indicator, the method comprises:
determining a distance between an actual position of the aircraft and the entry point of the incursion-risk area; and
displaying, in the context-dependent information of the guidance tile, a gauge that identifies an amount of room available for maneuvering the aircraft before the second predetermined threshold.

9. The method according to claim 1, wherein the warning indicator is accompanied by an instruction to brake.

10. The method according to claim 1, wherein the warning indicator is accompanied by a sound indicating proximity to the entry point.

11. The method of claim 1, comprising:
displaying a navigation map of at least part of the airport environment which includes representations of runways and taxiways of the airport environment;
displaying in real-time a representation of an actual position of the aircraft in the airport environment on the navigation map;
displaying a guidance path on the navigation map identifying a path to be followed by the aircraft from the actual position to reach a destination in the airport environment; and
displaying one or more markers on the navigation map indicating waypoints along the guidance path, wherein the entry point to the incursion-risk area is represented by one of the one or more markers.

12. The method according to claim 11, wherein a stop bar crossing the taxiway at the entry point to the incursion-risk area is represented on the navigation map in association with the one of the one or more markers representing the entry point.

13. The method according to claim 11, wherein updating the context-dependent information to include the warning indicator comprises one or more of:
changing a color of the one of the one or more marker to one or more predetermined alert color; or
changing a color of a portion of the guidance path leading to the entry point to the incursion-risk area to the one or more predetermined alert color.

14. A non-transitory computer-readable storage medium having executable instructions stored thereon, which when read from the non-transitory computer-readable storage medium and executed by a processing circuit of a computing device causes the computing device to execute the method according to claim 1.

15. A monitoring equipment configured for being embedded in an aircraft and for managing an anti-incursion function of the aircraft taxiing within an airport environment, the monitoring equipment comprising electronic circuitry configured for:
displaying, by a human-machine interface of the monitoring equipment, a guidance tile that presents context-dependent information as the aircraft taxies within the airport environment;
wherein, when the monitoring equipment detects that the aircraft approaches within a first predetermined threshold of an entry point to an incursion-risk area, the electronic circuitry is configured for:
updating, by the human-machine interface, the context-dependent information to include a warning indicator; and
waiting, by the monitoring equipment, for a confirmation that the incursion-risk area is cleared; and
wherein, when the monitoring equipment detects that the aircraft approaches within a second predetermined threshold of the entry point to the incursion-risk area prior to receiving the confirmation that the incursion-risk area is cleared, the second predetermined threshold being lower than the first predetermined threshold, the electronic circuitry is configured for:
updating, by the human-machine interface, the context-dependent information to include a message indicating automatic braking of the aircraft; and
initiating automatic braking function of the aircraft when the aircraft fails to stop at most at the entry point to the incursion-risk area.

16. An aircraft including the monitoring equipment according to claim 15.
